(19) United States
(12) Patent Application Publication
(10) Pub. No.: US 2025/0205794 A1
(43) Pub. Date: Jun. 26, 2025

(54) REACTOR VESSEL CUTTING DEVICE AND METHOD

(71) Applicant: ATS AUTOMATION TOOLING SYSTEMS INC., Cambridge (CA)

(72) Inventors: David Morikawa, Cambridge (CA); Murray Edgar Taylor, Cambridge (CA); Brian Robert Campbell, Cambridge (CA); Kenneth Mark Johannesson, Cambridge (CA); Michael Stephen Adams, Cambridge (CA)

(21) Appl. No.: 18/845,417

(22) PCT Filed: Mar. 8, 2023
(86) PCT No.: PCT/CA2023/050302

§ 371 Date: Sep. 9, 2024

Related U.S. Application Data
(60) Provisional application No. 63/317,953, filed on Mar. 8, 2022.
(60) Provisional application No. 63/325,879, filed on Mar. 31, 2022.

(51) Int. Cl. B23D 45/02; B23D 45/12

(52) U.S. Cl. CPC B23D 45/027; B23D 45/128

(57) ABSTRACT

A reactor vessel cutting device, including a hoist system; a mechanical cutter; and a cutter carriage secured to the hoist system to be suspended by the hoist system. The cutter is secured to a carriage body of the cutter carriage to be carried by the carriage body. The cutter carriage includes a stabilization system secured to the carriage body and operable to hold the cutter carriage against a vessel wall of the reactor vessel. The cutter carriage is operable to apply the cutter to the vessel wall in a mechanical cutting operation when the cutter carriage is held against the vessel wall by the stabilization system. The hoist system is configured to bear the weight of the cutter and the cutter carriage during the mechanical cutting operation and the stabilization system is configured to carry cutting forces generated during the mechanical cutting operation.

### FIELD

The specification relates generally to cutting a reactor vessel, and more specifically to mechanical cutting of the reactor vessel.

### BACKGROUND

U.S. Pat. No. 4,813,313 to Ichikawa et al. (“Ichikawa”) purports to disclose an apparatus for demolishing a reactor shield wall. Ichikawa purports to disclose that the apparatus has a pillar extending from the top side of the reactor toward the bottom of the reactor, an upper support device for supporting the upper portion of the pillar at the top side of the reactor, and cutting devices mounted to the pillar so as to be upwardly and downwardly movable along the pillar. Ichikawa purports to disclose that the pillar is rotatably supported by the support device. Ichikawa purports to disclose that the upper support device has drive devices for rotating the pillar. Ichikawa purports to disclose that the cutting devices are caused to swing in the reactor interior by rotating the pillar. Ichikawa purports to disclose that the drive devices are disposed at the top side of the reactor, and this permits easy maintenance and inspection.

U.S. Pat. No. 5,268,550 to Blocquel et al. (“Blocquel”) purports to disclose a method and device for removal of a specimen, especially a parallelepipedal specimen, from within the internal wall of the vessel of a nuclear reactor which is at the end of its service and whose core has previously been dismantled, but which retains a high residual radioactivity. Blocquel purports to disclose a rotating platform carrying tools for cutting out by electrical discharge is inserted into the vessel, maintained under protective water. Blocquel purports to disclose a first electrode produces a recess in a direction perpendicular to the internal wall of the vessel, delimiting the external contour of the specimen, and a second electrode cuts the rear of the latter to a specified depth, before the withdrawal thereof from the wall.

U.S. Pat. No. 10,994,354 to LaGuardia et al. (“LaGuardia”) purports to disclose arc saw blades and systems and methods for segmenting components utilizing improved arc saw blades. LaGuardia purports to disclose hazardous material segmenting and/or segmenting in hazardous environments, such as nuclear power plant component and equipment dismantling, or any application where metallic components are to be segmented for removal and disposal.

### SUMMARY

The following summary is intended to introduce the reader to various aspects of the applicant's teaching, but not to define any invention.

According to some aspects, there is provided a reactor vessel cutting device, comprising: a hoist system; a cutter; and a cutter carriage secured to the hoist system to be suspended by the hoist system, and wherein the cutter is secured to a carriage body of the cutter carriage to be carried by the carriage body, wherein the cutter carriage includes a magnetic stabilization system secured to the carriage body and operable to hold the cutter carriage to a vessel wall of the reactor vessel, and wherein the cutter carriage is operable to move the cutter relative to the vessel wall while the cutter carriage is held against the vessel wall by the magnetic stabilization system.

In some examples, the cutter carriage is operable to apply the cutter to the vessel wall in a mechanical cutting operation while the cutter carriage is held against the vessel wall by the magnetic stabilization system.

In some examples, the hoist system includes a support base and a retractable suspension line to which the cutter carriage is secured.

In some examples, the hoist system is configured to bear the weight of the cutter carriage and the cutter.

In some examples, the hoist system includes a chain fall hoist, and the cutter carriage is secured to a chain of the chain fall hoist.

In some examples, the hoist system includes two chains in parallel, and the cutter carriage is secured to each of the two chains.

In some examples, the magnetic stabilization system includes a plurality of magnets spaced apart from one another and arranged to each touch the vessel wall such that the cutter carriage is held against the vessel wall at multiple points.

In some examples, the multiple points are within a stabilization footprint on the vessel wall, and the cutter carriage is operable to move the cutter within an operational plane, and the stabilization footprint does not extend across the operational plane.

In some examples, the magnetic stabilization system includes electromagnets.

In some examples, the magnetic stabilization system includes an outside face to be directed towards the vessel wall, and a gripper insert is set in the outside face, the gripper insert including an abrasive surface.

In some examples, the gripper insert is a carbide gripper.

In some examples, the outside face is a surface of a magnet.

In some examples, the cutter carriage incudes a first body with a first track and a second body with a second track, the second body secured to the first body to move along the first track, and the cutter secured to the second body to move along the second track.

In some examples, the first track and the second track are linear tracks and extend perpendicular to one another.

In some examples, the cutter includes a circular saw blade.

According to some aspects, there is provided a reactor vessel cutting device, comprising: a hoist system; a cutter; and a cutter carriage secured to the hoist system to be suspended by the hoist system, and wherein the cutter is secured to a carriage body of the cutter carriage to be carried by the carriage body, wherein the cutter carriage includes a wedge stabilization system secured to the carriage body and operable to hold the cutter carriage against a vessel wall of the reactor vessel by wedging the cutter carriage within the reactor vessel, and wherein the cutter carriage is operable to move the cutter relative to the vessel wall when the cutter carriage is held against the vessel wall.

In some examples, the cutter carriage is operable to apply the cutter to the vessel wall in a mechanical cutting operation while the cutter carriage is held against the vessel wall by the wedge stabilization system.

In some examples, the wedge stabilization system includes an extendable ram secured to the carriage body and including a foot for bearing against an internal wall of the reactor vessel.

In some examples, the cutter carriage includes only one extendible ram, the extendible ram secured to the carriage body and arranged to extend the foot on a first side of the cutter carriage to bear against the internal wall of the reactor vessel and force an opposite side of the cutter carriage towards an opposite surface of the internal wall of the reactor vessel.

In some examples, the wedge stabilization system is arranged to wedge the cutter carriage within the reactor vessel with the cutter carriage touching an internal wall of the reactor vessel within a stabilization footprint, and the cutter carriage is operable to move the cutter within an operational plane, and the stabilization footprint does not extend across the operational plane.

According to some aspects, there is provided a method of cutting a reactor vessel, comprising: making a set of longitudinal cuts in an annular wall of the reactor vessel, the annular wall extending between a first end and a second end of the reactor vessel, each longitudinal cut of the set of longitudinal cuts extending parallel to a longitudinal axis of the annular wall, the set of longitudinal cuts spaced about the longitudinal axis and each extending along a common portion of the longitudinal axis; fastening adjacent edges of the annular wall together across longitudinal cuts; and making an angular cut that intersects each of the longitudinal cuts.

In some examples, fastening the adjacent edges together includes installing a clamp in each longitudinal cut to hold together adjacent edges of the annular wall.

In some examples, the first end of the reactor vessel is an open end, and each longitudinal cut extends from the open end, and the angular cut frees an annular ring from a remainder of the annular wall, the annular ring including angular segments of the annular wall held together by the clamps.

In some examples, the method further comprises removing the clamps from the longitudinal cuts to separate the angular segments.

In some examples, each clamp is a hydraulic clamp.

In some examples, the method further comprises using Minimum Quantity Lubrication (MQL) while making the set of longitudinal cuts and/or the annular cut.

In some examples, the method further comprises circulating a fluid over a cutting area while making the set of longitudinal cuts and/or the annular cut, circulating the fluid using a pump in the second end of the reactor vessel to feed fluid from the second end to the cutting area.

In some examples, the longitudinal cuts are made with a reactor vessel cutting device in a first configuration and the angular cut is made with: the reactor vessel cutting device in a second configuration in which a saw carriage of the reactor vessel cutting device is rotated 90 degrees relative to the first configuration, or a second of the reactor vessel cutting device, a saw carriage of the second of the reactor vessel cutting device being rotated when the angular cut is made by 90 degrees relative to the saw carriage of the reactor vessel cutting device when the longitudinal cuts are made.

According to some aspects, there is provided a reactor vessel cutting device, comprising: a hoist system; a mechanical cutter; and a cutter carriage secured to the hoist system to be suspended by the hoist system, and wherein the cutter is secured to a carriage body of the cutter carriage to be carried by the carriage body, wherein the cutter carriage includes a stabilization system secured to the carriage body and operable to hold the cutter carriage against a vessel wall of the reactor vessel, wherein the cutter carriage is operable to apply the cutter to the vessel wall in a mechanical cutting operation when the cutter carriage is held against the vessel wall by the stabilization system, and wherein the hoist system is configured to bear the weight of the cutter and the cutter carriage during the mechanical cutting operation and the stabilization system is configured to carry cutting forces generated during the mechanical cutting operation.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or process described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

Although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the examples described herein may be practiced without these specific details. In other instances, well-known methods, procedures, and components have not been described in detail so as not to obscure the examples described herein.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

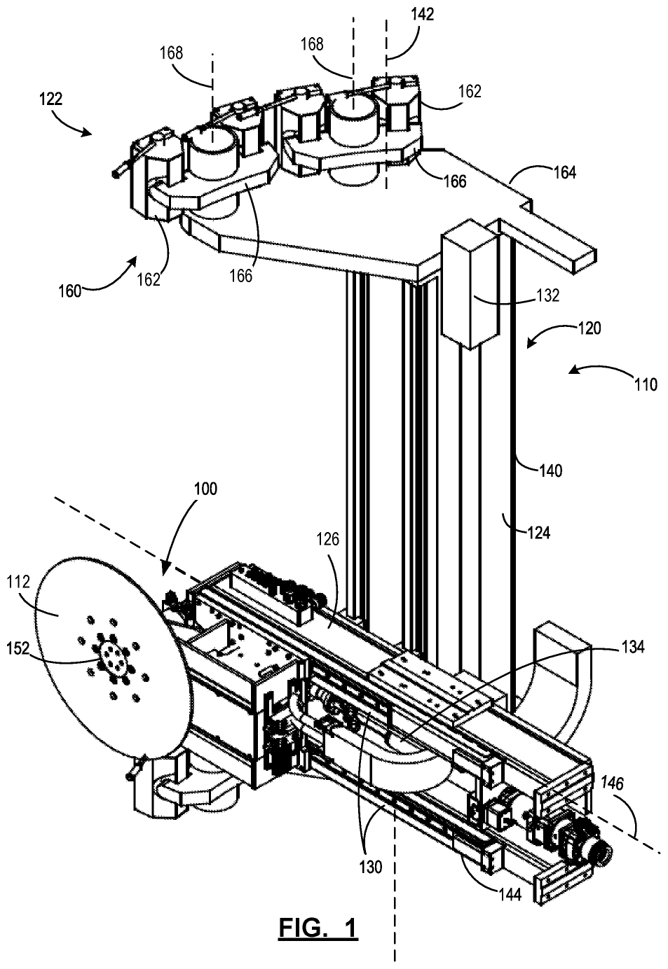

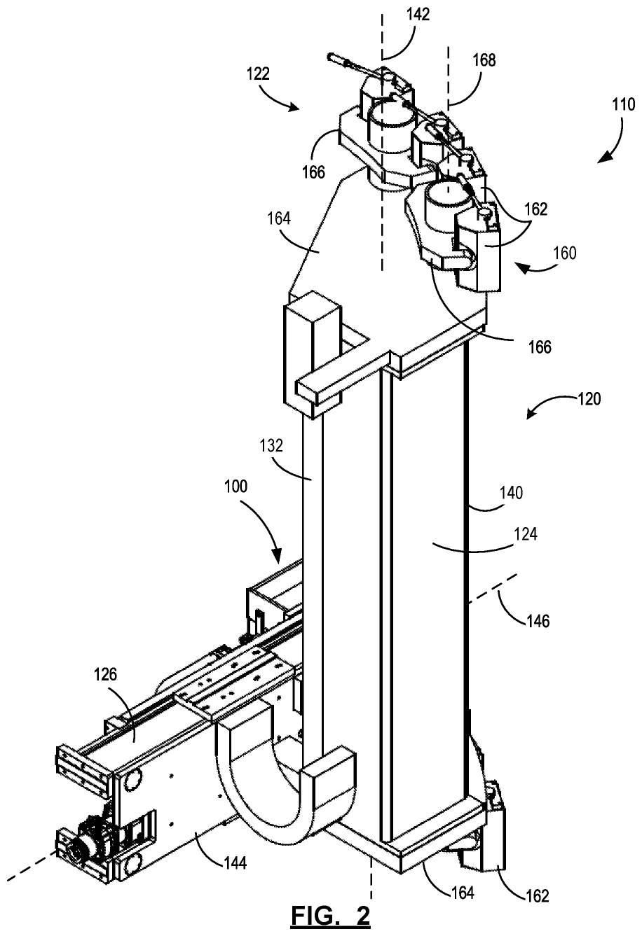

Referring to FIGS. 1 and 2, illustrated is cutter 100 and cutter carriage 110. The cutter 100 is secured to the cutter carriage 110. The cutter may be a mechanical cutter. The cutter may be a saw. In the illustrated example, the cutter is a saw and includes a circular saw blade 112. The cutter carriage 110 includes a carriage body 120 and a stabilization system 122. The cutter 100 may be used for segmenting a pressure vessel, and can be applied to the walls of the vessel and/or to the reactor vessel internals.

The cutter 100 is secured to the carriage body 120, and the cutter carriage 110 is operable to move the cutter 100 when the cutter carriage 110 is held to a portion of a vessel (e.g., a wall of the vessel). While the cutter 100 may be mounted to the carriage body 120 in various ways, in the illustrated example the cutter carriage 110 includes tracks along which mounted bodies may move. The cutter carriage 110 and/or carriage body 120 includes a first body 124 and a second body 126 moveable relative to the first body 124. In the illustrated example, the first body 124 and the second body 126 each include a track. The first body 124 includes a first track 128, the second body 126 includes a second track 130. The second body 126 is mounted to the first track 128 of the first body 124 to move along the first track. The cutter 100 is mounted to the second track 130 to move along the second track 130.

As in the illustrated example, the first track 128 and the second track 130 may be linear tracks. As in the illustrated example, the first track 128 and the second track 130 may extend perpendicular to one another. In the illustrated example, the first body 124 includes the first track 128 and an elongated beam 140 extending along a cross axis 142. The second body 126 also includes an elongated beam 144 in addition to the second track 130. The second elongated beam 144 extends along a plunge axis 146.

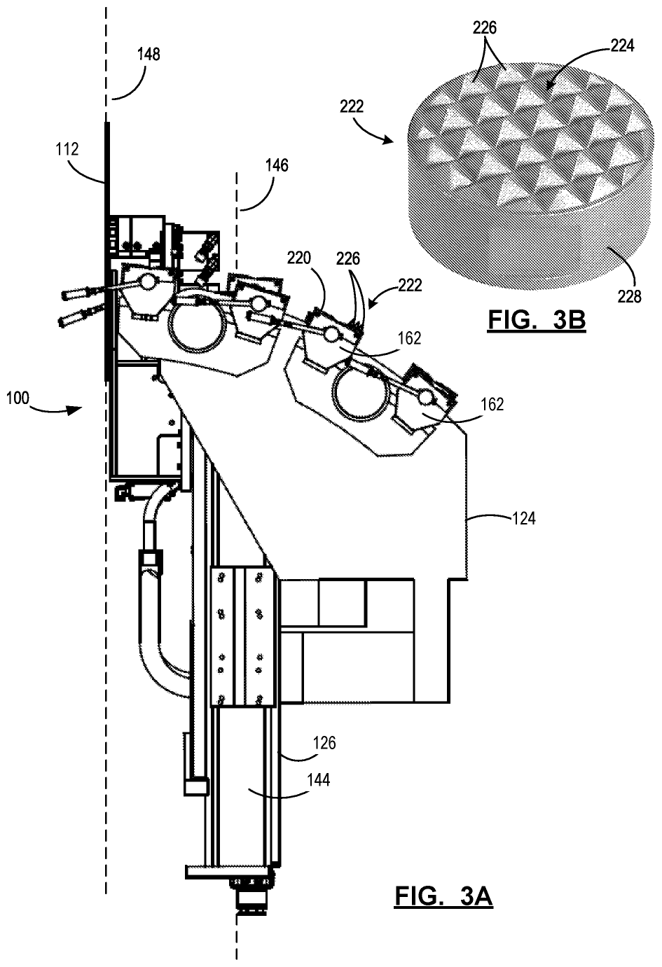

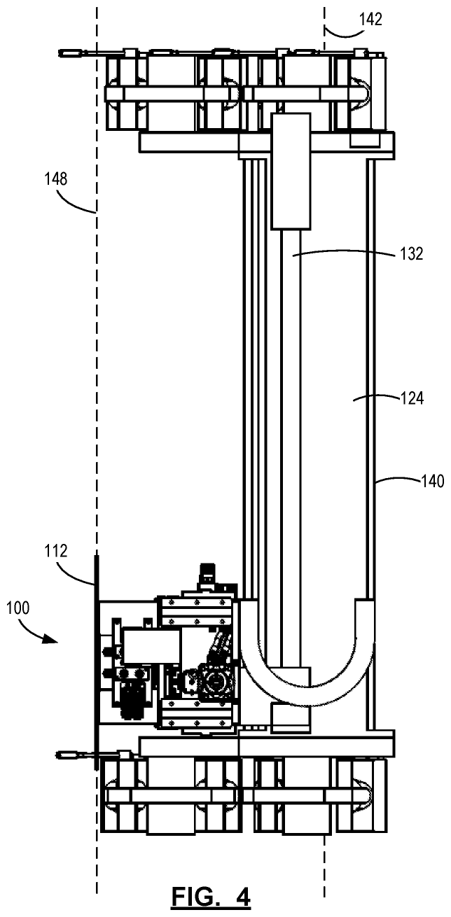

Referring to FIGS. 3A and 4, movement along the plunge axis 146 and/or the cross axis 142 allows the cutter 100 to be repositioned within an operational plane 148. The blade 112 of the cutter 100 may extend in the operational plane 148, and the carriage 110 may be configured to move the blade 112 relative to the carriage 110 only within the operational plane. In other words, the blade 112 may be moved relative to the carriage 110 only parallel to the main face of the blade.

Referring again to FIGS. 1 and 2, actuators drive relative movement between bodies. In the illustrated example, the cutter carriage 110 includes a ball screw drive system 132 coupled to the first and second bodies 124, 126 operable to move the second body 126 along the first track 128. The cutter carriage 110 also includes a hydraulic drive system 134 coupled to the cutter 100 and the second body 126 and operable to move the cutter 100 along the second track 130.

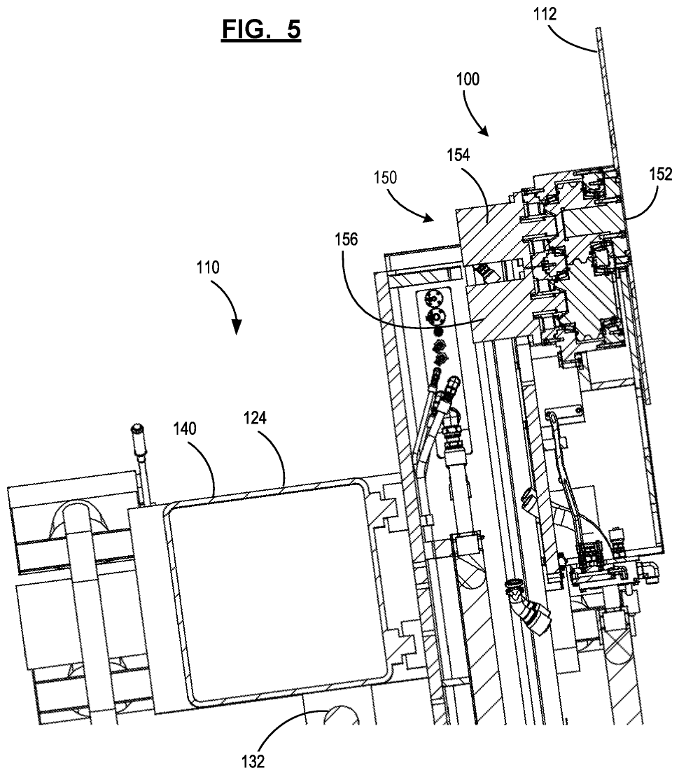

Referring now to FIG. 5, The cutter 100 may include a drive system 150. The drive system 150 includes a blade holder 152 of small diameter, such that a main portion of the radius of the blade 112 is exposed. For example, more than 50%, more than 60% or more than 75% of the radius of the blade 112 may be exposed. This can allow the blade 112 to extend deep into a cut in a wall of the vessel. To supply power, the drive system 150 includes a plurality of motors linked in series and linked to the holder 152. In the illustrated example, a first hydraulic motor 154 is linked in series with a second hydraulic motor 156. Together, the motors 154, 156 drive the torque of a larger motor that would otherwise require a larger portion of the radius of the blade 112 or a gear box. The drive system 150 may include a train to, e.g., allow the holder 152 at the centre of the blade 112 to be small.

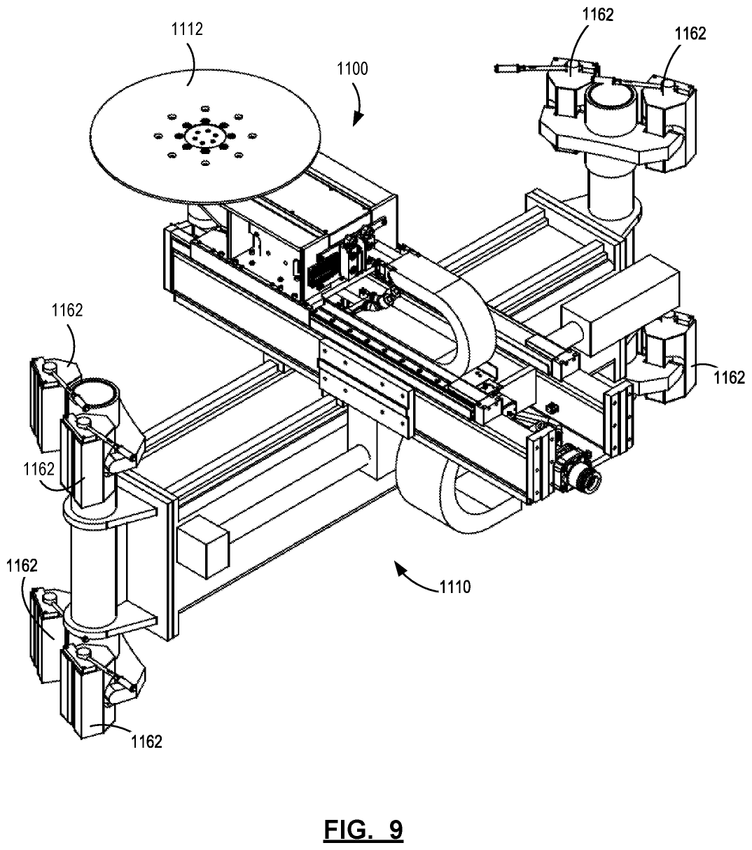

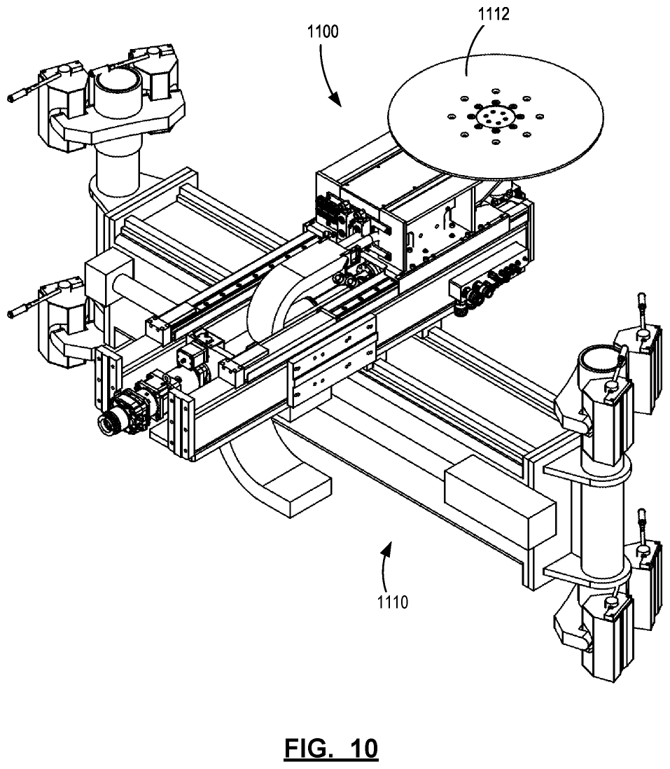

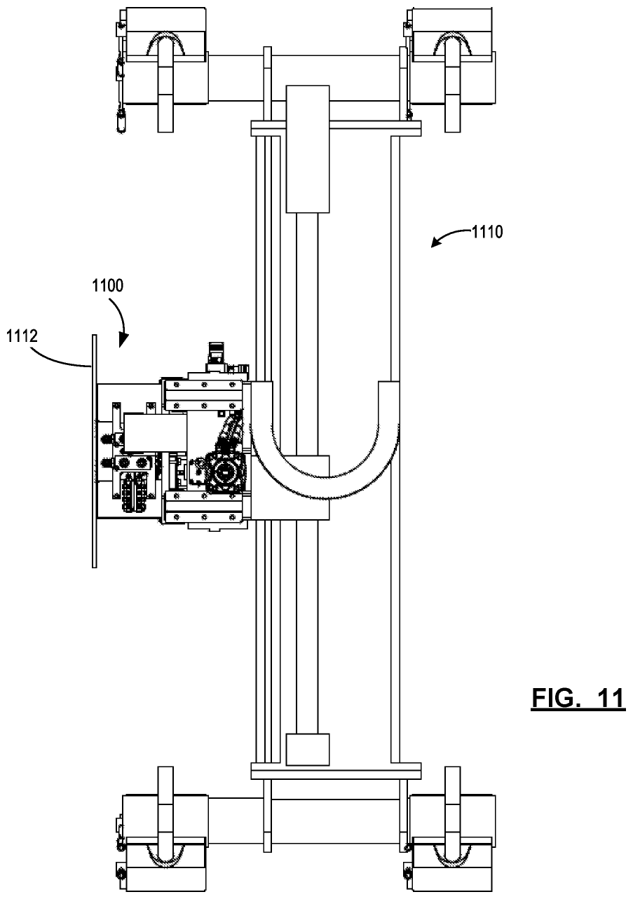

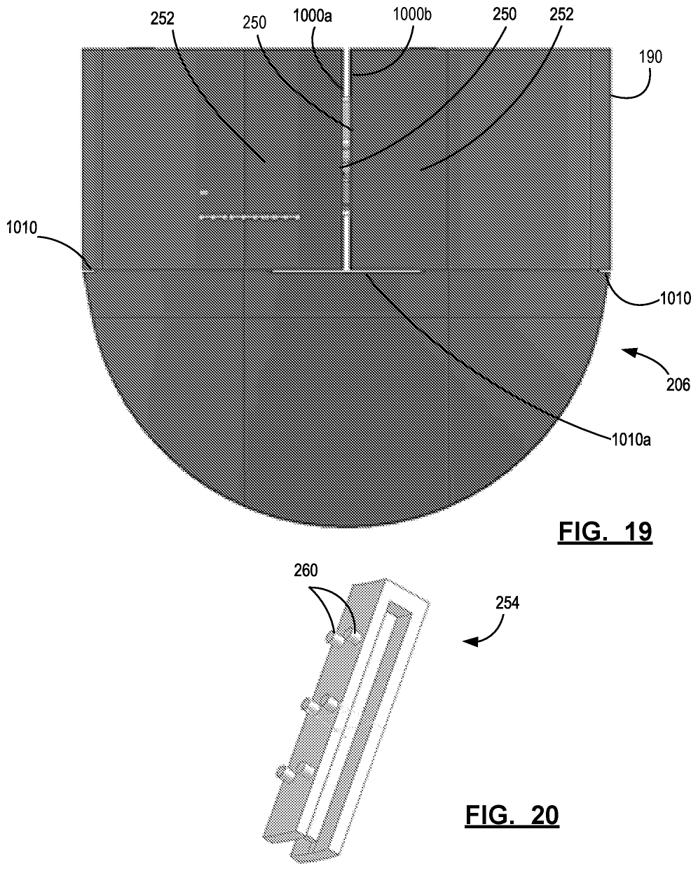

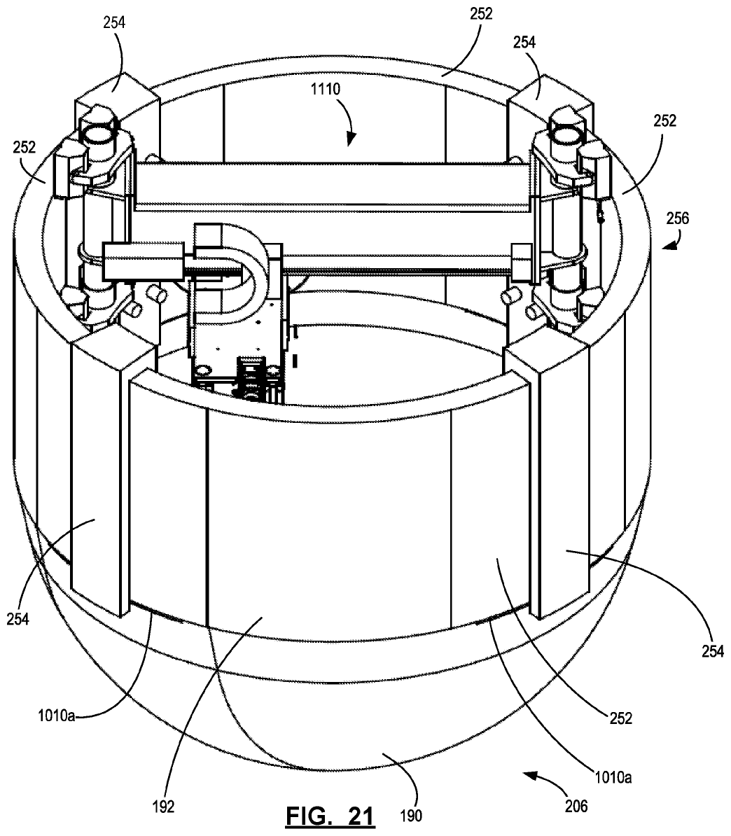

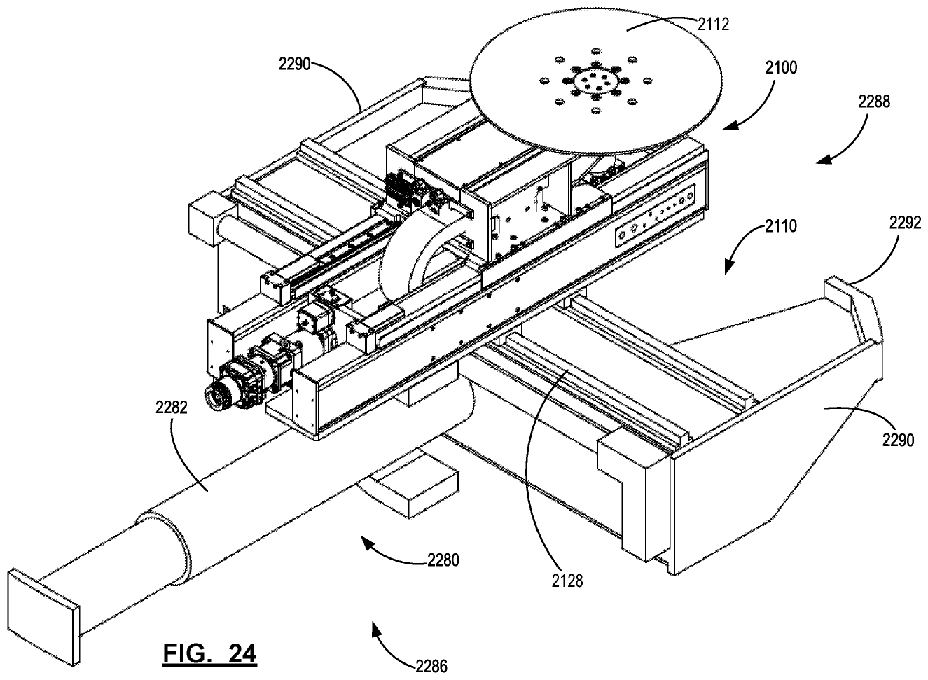

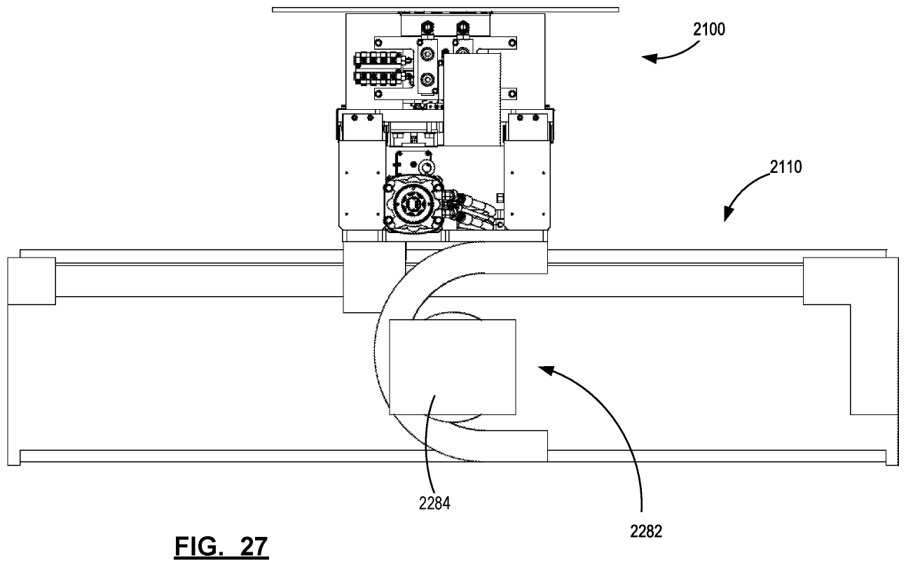

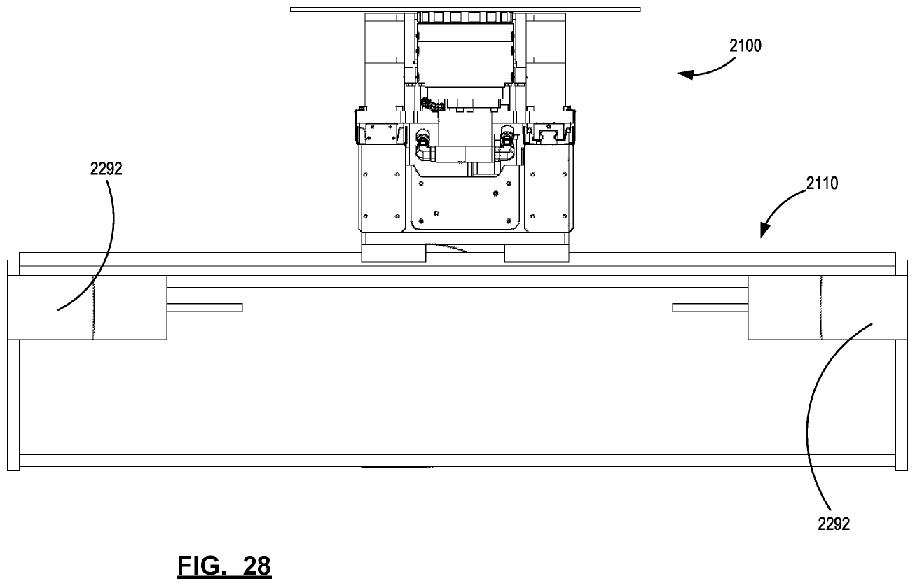

Referring again to FIGS. 1 and 2, the stabilization system 122 may assist in holding the cutter carriage 110 in position during a cutting operation of the cutter 100. During cutting, particularly mechanical cutting, the cutter carriage 110 may vibrate or otherwise shift its position due to forces generated by the cutting operation. The stabilization system 122 may be, e.g., a magnetic stabilization system (FIGS. 1 to 22) or a wedge stabilization system (FIGS. 23 to 30). The weight of the cutter 100 and/or cutter carriage 110 may be carried by a further system, such as a hoist system described further below, which allows the stabilization system 122 to be less powerful than would be needed to hold up the weight.

Referring to FIGS. 1 and 2, a magnetic stabilization system 160 is secured to the carriage body 120. The stabilization system may be secured by, e.g., bolting, welding, or adhering the stabilization system to the carriage body 120. The magnetic stabilization system 160 includes magnets 162 secured to the carriage body 120 directly or indirectly, to draw the carriage body to a surface (e.g., a wall) of the vessel (i.e., the workpiece). The vessel surface (e.g., the vessel wall) may be formed of a ferromagnetic material.

The stabilization system 122 can be transitioned by an operator between a stabilization configuration and a repositioning configuration. For the magnetic stabilization system 160, the magnets 162 may be electromagnets, and the operation may configure the system 160 in a stabilization configuration by increasing electrical power to the magnets 162 and may configure the system 160 in a repositioning configuration by decreasing electrical power to the magnets 162.

On each end of the first body 124 is a flange 164. To each flange 164 is mounted a plurality of the magnets 162. The magnets 162 may be mounted rigidly or may be mounted via an adjustable mounting system 166. For example, the adjustable mounting system 166 may allow pivotal movement about a pivot axis 168 that extends parallel to the cross axis 162. As described further below, the hoist system 180 (i.e., the retractable line 184) may be secured to the flange 164.

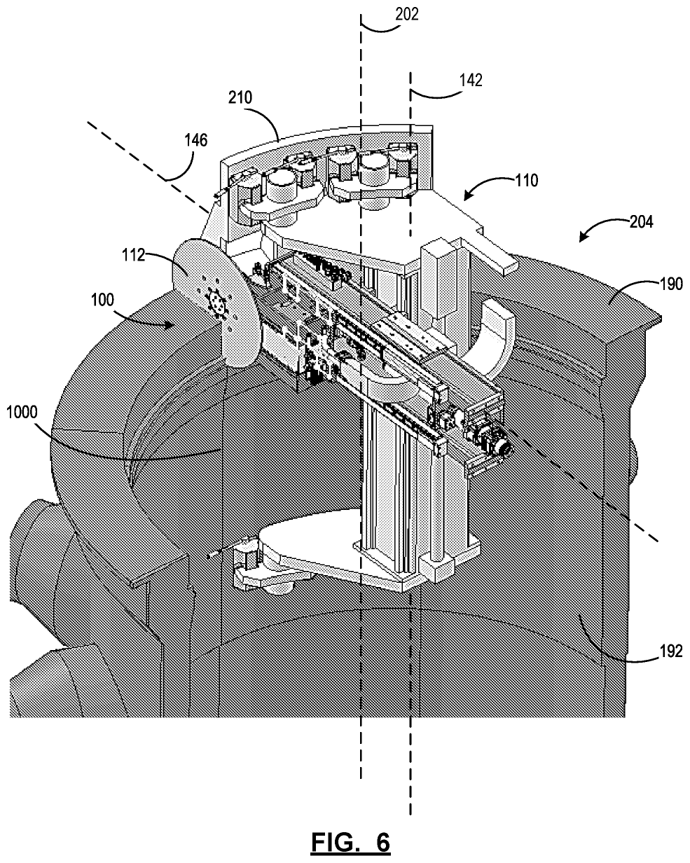

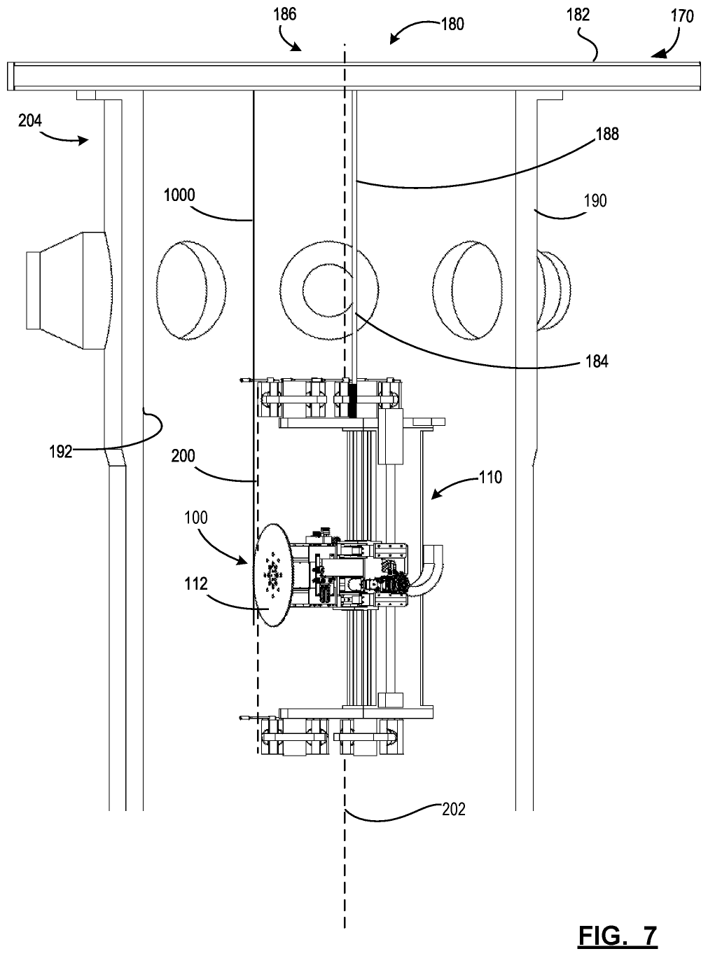

Referring to FIGS. 6 to 8, the cutter 100 and cutter carriage 110 are parts of a reactor vessel cutting device 170. The reactor vessel cutting device 170 also includes a hoist system 180. The cutter carriage 110 is secured to the hoist system 180 to be suspended by the hoist system 180. The reactor vessel cutting device 170 can be used to cut a reactor vessel 190 of a nuclear reactor, including a wall of the vessel and/or the reactor vessel internals. As illustrated particularly in FIGS. 7 and 8, the reactor vessel cutting device 170 is arranged to cut the vessel 190, with the hoist system 180 supporting the cutter carriage 110 suspended in the reactor vessel 190.

In the illustrated example, the hoist system 180 includes a support base 182 and a retractable suspension line 184 to which the cutter carriage 110 is secured. The support base 182 may be set up above the vessel 190, such as on the floor of a chamber into which the vessel 190 opens at an upper end of the vessel 190. The support base 182 may be, e.g., a beam laid across the opening into the vessel 190 from which a retractable suspension line 184 can extend to suspend the cutter carriage 110 within the vessel 190. The hoist system 180 is configured to bear the weight of the cutter carriage 110 and the cutter 100. This allows the stabilization system 122 to be a less powerful system than would be needed to hold up the weight of the carriage 110 and cutter 100 (e.g., smaller magnets needed). The hoist system 180 may include a chain fall hoist 186, and the cutter carriage is secured to a chain 188 of the chain fall hoist 186. The magnets 162 may be, e.g., between 1000 and 20,000 pounds each, between 2,500 and 10,000 pounds each, or about 5,000 pounds each. The stabilization system may include, e.g., between 1 and 20 magnets, 2 and 15 magnets, or between 5 and 10 magnets 162.

The stabilization system 122 is operable to hold the cutter carriage to a vessel wall 192 of the reactor vessel 190. The cutter carriage 110 is operable to move the cutter 100 relative to the vessel wall 192 while the cutter carriage 110 is held against the vessel wall 192 by the stabilization system 122. The cutter carriage 110 is operable to apply the cutter 100 to the vessel wall 192 in a mechanical cutting operation while the cutter carriage 110 is held against the vessel wall 182 by the stabilization system 122.

The magnets 162 of the illustrated magnetic stabilization system 150 are arranged to each face the vessel wall 192 of the vessel 190. The magnets 162 may be arranged to each touch the vessel wall 192 when the cutter carriage 100 is positioned in the vessel 182. The magnets 162 may be arranged such that the cutter carriage 110 is held against the vessel wall 192 at multiple points. In the illustrated example, the multiple points are within a stabilization footprint 200 on the vessel wall 192, and the stabilization footprint 200 does not extend across the operational plane 148 within which the cutter 100 may be repositioned by the carriage 110.

Since the footprint 200 does not extend over the operational plane 148, the stabilization coupling between the cutter carriage 110 and the vessel wall 190 may be to one side of a cut made by the cutter 100 as the cutter 100 is applied to the wall 190 along a linear cut line. As illustrated in FIGS. 6 to 8, the cutter 100 may be applied to make a longitudinal cut 1000 in the vessel wall 192, generally parallel to a longitudinal axis 202 of the vessel 190. The wall 192 may be an annular wall that extends along the axis 202 between a first end 204 of the vessel 190 and a second end 206 of the vessel 190.

Referring to FIG. 6, in some embodiments a run-out plate 210 may be used to provide a surface to which the stabilization system 122 may hold when the cutter 100 is being applied at an open end of the vessel 190. The run-out plate 210 may be secured to, e.g., bolted onto, the vessel 190 to extend a support surface for the stabilization system 122.

The cutting device 170 may be positioned with the cutter 100 against the wall 192 to make a longitudinal cut, the cutter 100 then makes the longitudinal cut as far as it is able along the cross axis 142, the cutting device 170 can then be repositioned at another point, e.g., another point along the longitudinal axis of the vessel 190, and the cutter 100 used to continue the longitudinal cut and/or make a separate longitudinal cut. For example, as illustrated in FIG. 6, the reactor vessel cutting device 170 may be positioned at the first end of the vessel 190, used to cut from the open first end 204 longitudinally towards the second end 206 of the vessel 190 to the extent that the second body 126 may travel along the track 128 of the first body 124, and then the cutting device 170 may be repositioned at a lower point to continue the longitudinal cut.

Referring to FIGS. 3A and 3B, in some embodiments the stabilization system 122 includes an outside face 220 to be directed towards the vessel wall 192, and a gripper insert 222 is set in the outside face 220. The gripper insert 222 includes an abrasive surface 224 to contact the surface of the vessel wall 192. The abrasive surface of the gripper is provided to dig into the surface of the vessel wall 192 to help hold the carriage 110 in position. This may mar, scratch or otherwise deface the vessel wall 192, but assist in preventing slippage. For example, the gripper insert may be a carbide gripper with tips 226 projecting from a main gripper body 228. In some examples, the gripper insert 222 is a carbide gripper. In some examples, the outside face 220 is a surface of a magnet 162.

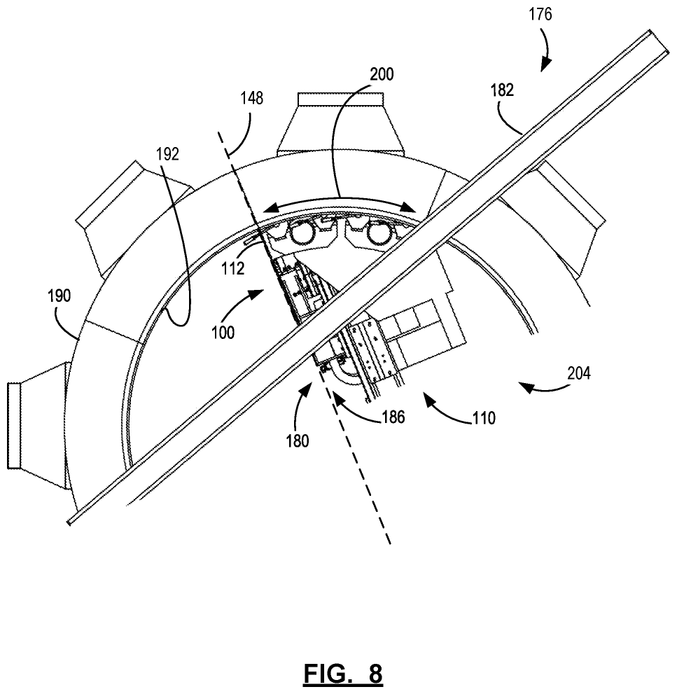

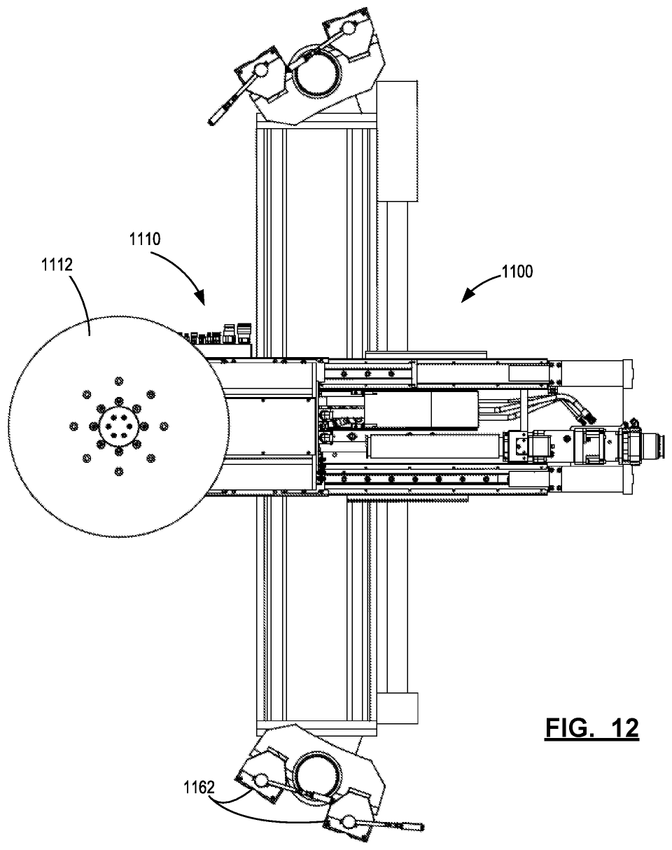

FIGS. 1 to 4 and 6 to 8 show the carriage 110 configured for making longitudinal cuts in the annular vessel wall 192. Referring now to FIGS. 9 to 22, illustrated is a similar reactor vessel cutting device 1170. The reactor vessel cutting device 1170 (FIG. 14) is similar in many aspects to the reactor vessel cutting device 170, and similar features are indicated by similar reference numbers incremented by 1000.

The carriage 1110 of the reactor vessel cutting device 1170 is configured for making angular cuts in the annular vessel wall 192. Referring in particular to FIG. 14, the stabilization system 1122 has magnets 1162 positioned on a flange 1230 on each end of the first body 1124. The magnets 1162 may be mounted rigidly or via an adjustable mounting system 1232. For example, the adjustable mounting system 1232 may allow pivotal movement about a pivot axis 1234 that extends perpendicular to the cross axis 1162.

As illustrated in FIG. 14, the carriage 1110 is suspended by the hoist system 1180. The hoist system 1180 includes a chain fall hoist with two chains 1188 in parallel, and the cutter carriage 1110 is secured to each of the two chains 1188.

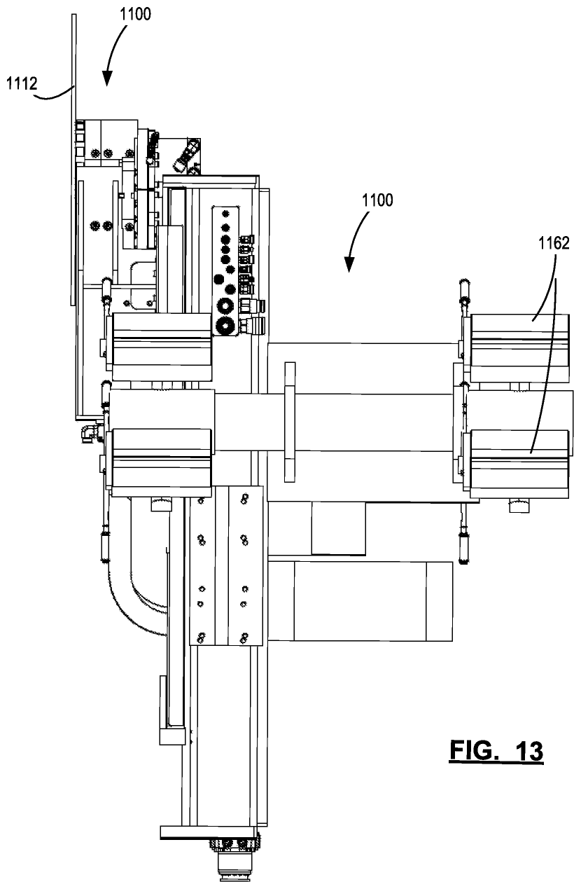

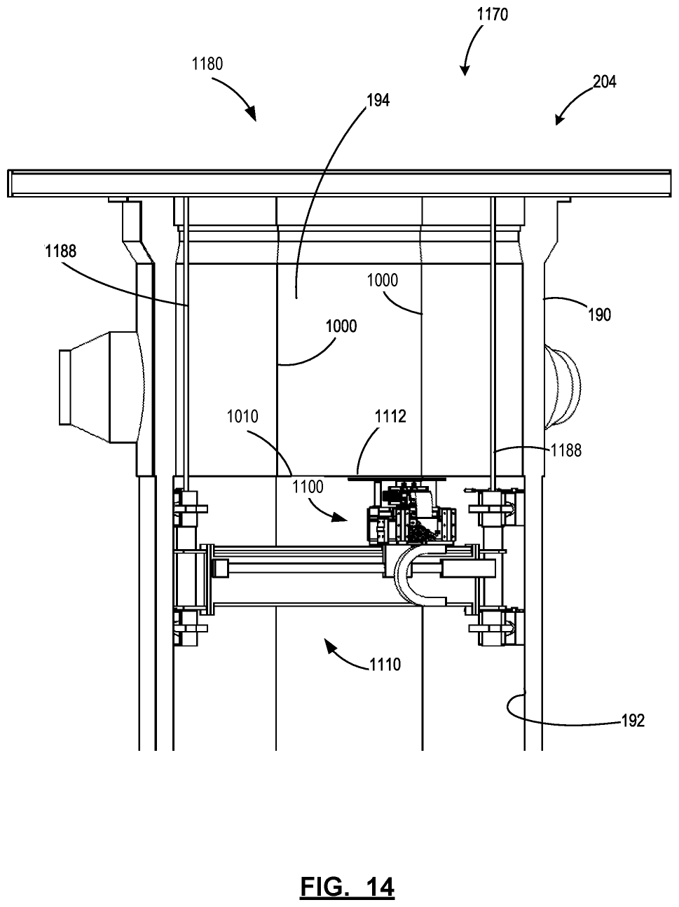

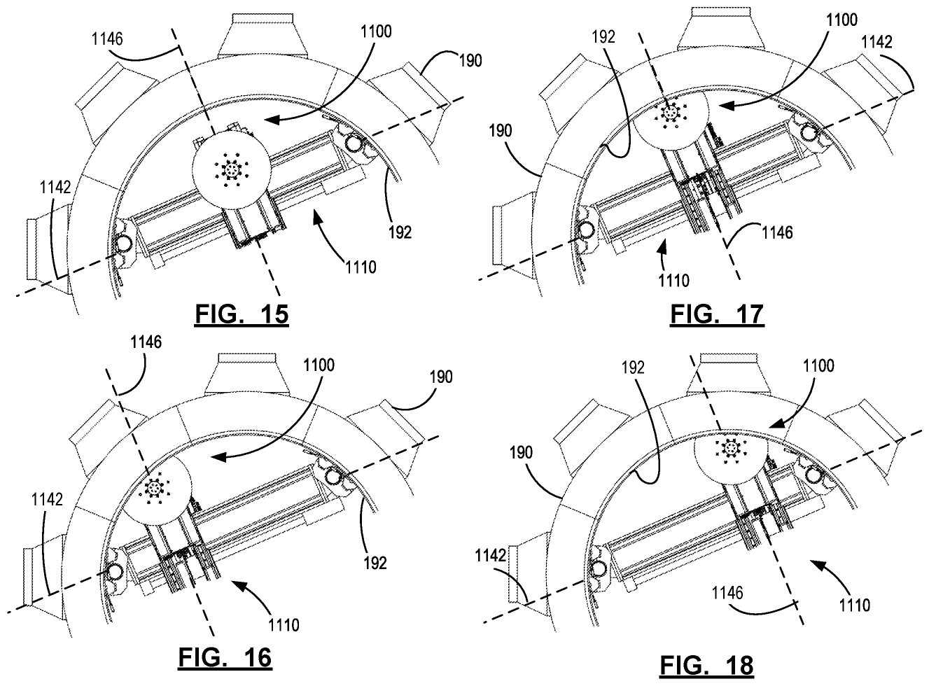

Referring now to FIGS. 15 to 18, the cutter carriage 1110 is operable to apply the cutter 1100 to the vessel wall 192 in a cutting operation. The cutter carriage 1110 moves the cutter 1100 into contact with the wall 192 (FIG. 16) and moves the cutter 1100 along the wall 192 (FIGS. 17 and 18) including moving the cutter parallel to each of the plunge axis 1146 and the cross axis 1142.

Referring again to FIG. 14, the cutter 100 and/or cutter 1100 may be used to free a section 194 of the wall 192. For example, once two longitudinal cuts 1000 are made with each extending from the open first end 204 of the vessel 190 and an angular cut 1010 made that intersects each of the longitudinal cuts, the section 194 may be free of the remainder of the wall 192. The free section 194 may be lifted away from the remainder, e.g., by a crane or other hoist system. If the vessel 190 is being decommissioned, the free section 194 may be removed and disposed of.

Referring now to FIGS. 19 to 22, in some examples, when a longitudinal cut is made in the annular wall 192 of the vessel 190 adjacent edges 250 of the annular wall are held together across the longitudinal cuts. The adjacent edges 250 may be held together using fasteners, and the wall portions 252 and fasteners 254 together form an annular ring.

The adjacent edges 250 may be held together when, e.g., the cutting device 170 and/or cutting device 1170 reach the second end 206 of the vessel 190. At the second end 206 the cutting device 170 and/or cutting device 1170 may not have space to be positioned below the desired angular cut. Accordingly, the wall portions 252 above the desired angular cut may be held together in an annular ring 256 to support the cutting device 170 and/or cutting device 1170 while the angular cut(s) are made.

In some examples, the cutting device 170 and/or cutting device 1170 is used to make a first longitudinal cut 1000a and then a second longitudinal cut 1000b within a short distance of the first, such as within 5 degrees, 3 degrees, or 1 degree of the inner circumference of the annular wall 192. The cutting device 170 and/or cutting device 1170 is used to make a short angular cut 1010a (e.g., less than 10 degrees, less than 5 degrees, or less than 3 degrees out from the first and second longitudinal cuts) that intersects the first and second longitudinal cuts, and a thin strip of the annular wall 192 is removed to make space for a fastener 254. In the illustrated example, the fastener 254 is a hydraulic clamp, with hydraulic cylinders 260 to be actuated to hold the clamp to each of the adjacent edges 250 and thus hold the edges 250 together.

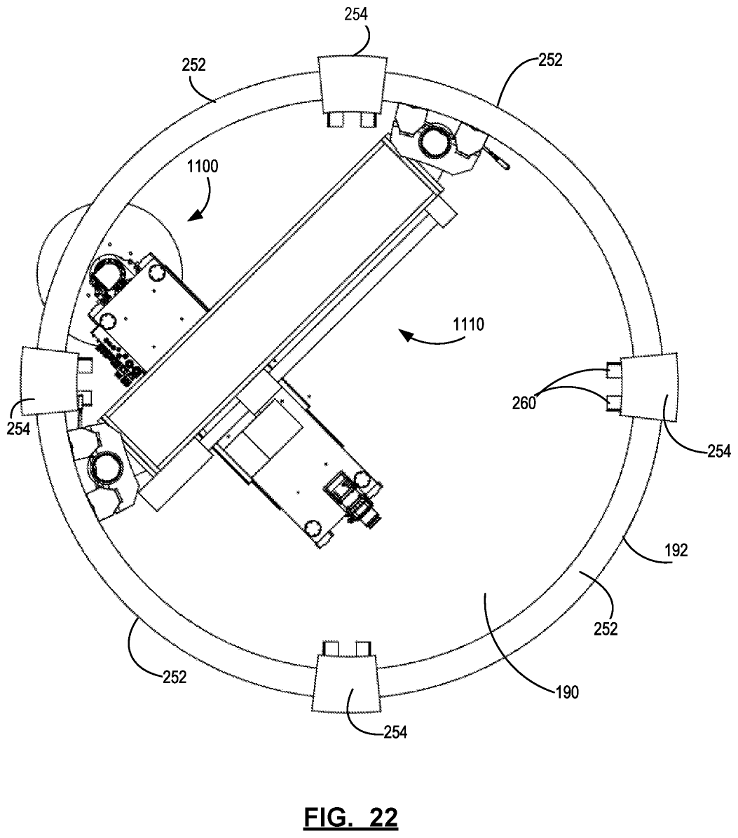

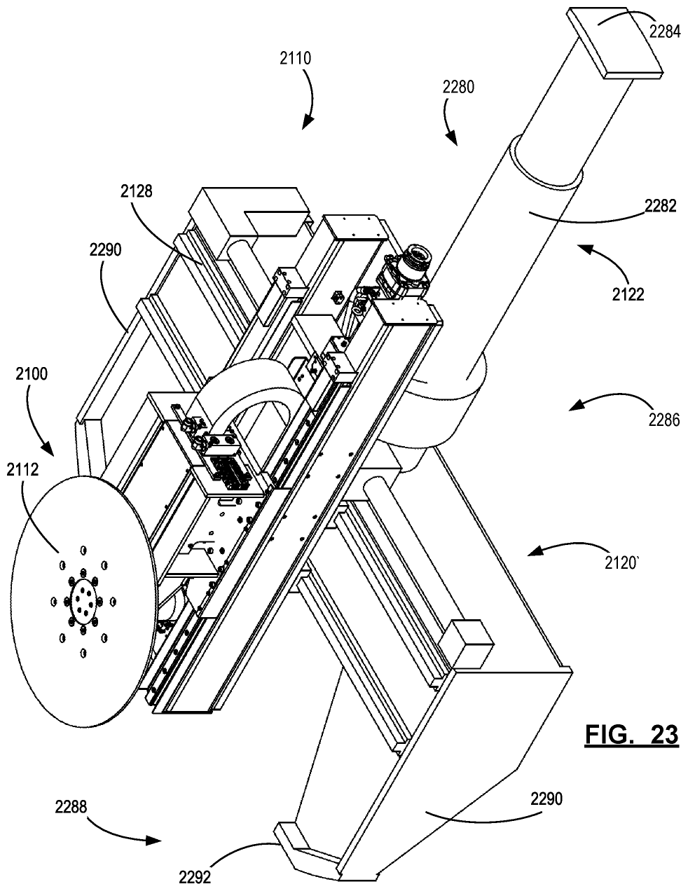

Referring to FIGS. 21 and 22, once the longitudinal cuts and short angular cuts are made and the fasteners 254 installed, the cutting device is used to join the short angular cuts 1010a and free the ring 256 from the remainder of the vessel 190. The fasters 254 may be removed from the ring 256, and the resulting free sections 194 disposed of.

Referring now to FIGS. 23 to 30, illustrated is another example of a cutting device 2170. The illustrated cutting device 2170 is similar in many respects to cutting device 170, and similar features are indicated by similar reference numbers, incremented by 2000.

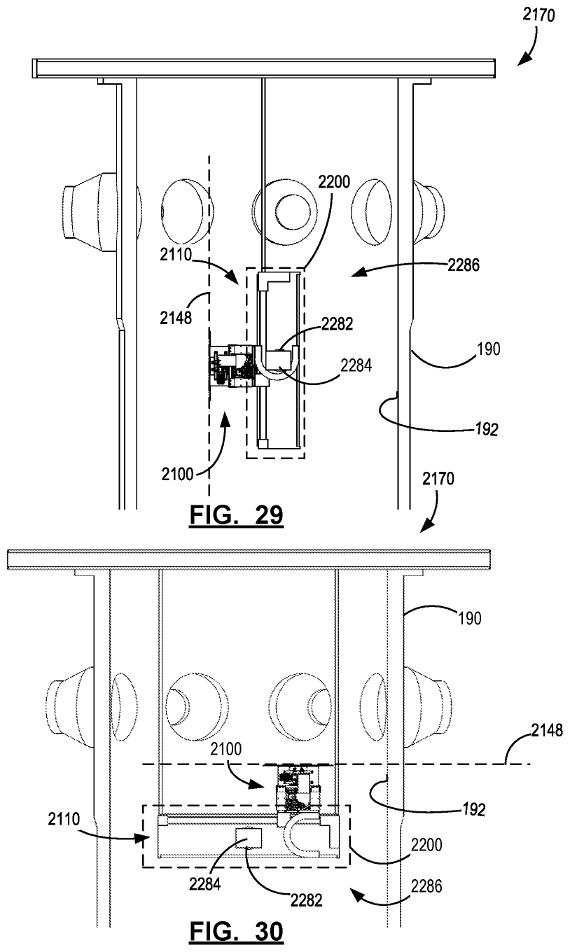

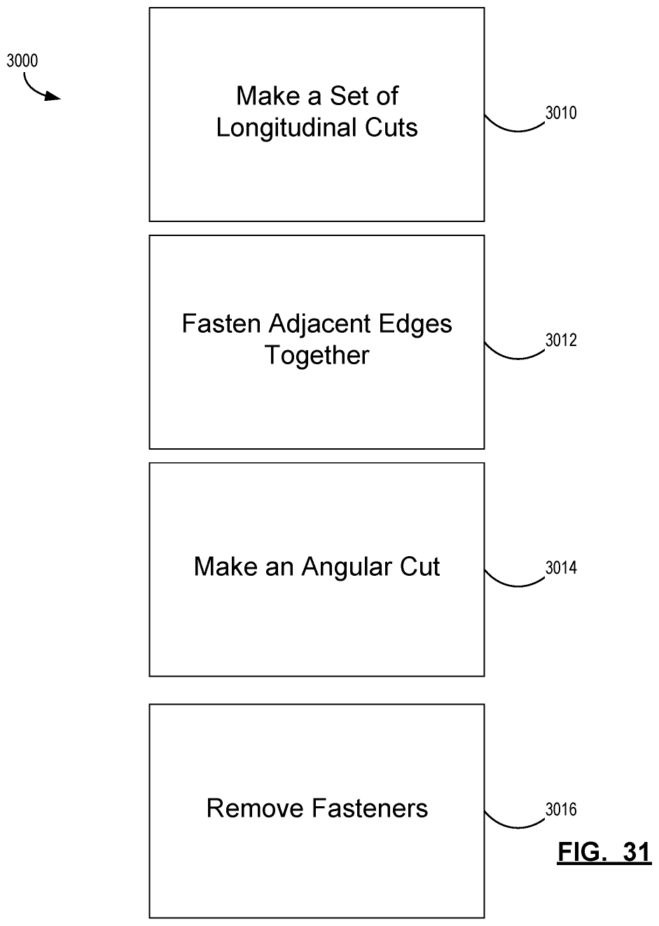

The cutting device 2170 (FIGS. 29 and 30) includes a stabilization system 2122. Stabilization system 2122 is a wedge stabilization system 2280 secured to the carriage body 2120 and operable to hold the cutter carriage 2110 against the vessel wall 192 of the reactor vessel 190 by wedging the cutter carriage 2110 within the reactor vessel 190. As illustrated in, e.g., FIGS. 29 and 30, the cutter carriage 2110 is operable to apply the cutter 2100 to the vessel wall 192 in a mechanical cutting operation while the cutter carriage 2110 is held against the vessel wall 192 by the wedge stabilization system 2280.

In the illustrated example, the wedge stabilization system 2280 includes an extendable ram 2282 secured to the carriage body 2120 and including a foot 2284 for bearing against an internal surface of the wall 192 of the reactor vessel 190. The ram 2282 includes a telescoping body bearing the foot 2284 such that the foot 2284 may be extended and retracted. For example, the ram 2282 may be a hydraulic ram. In some examples, as illustrated, the cutter carriage 2110 includes only one (i.e., a single) extendible ram 2282, though in other examples there may be more than one extendible ram 2282. The ram 2282 is secured to the carriage body 2120 and arranged to extend the foot 2284.

The illustrated ram 2282 is arranged to extend the foot 2284 on a first side 2286 of the cutter carriage 2110 to bear against the internal wall of the reactor vessel 190 and force an opposite side 2288 of the cutter carriage 2110 towards an opposite surface of the internal wall 192 of the reactor vessel 190. In the illustrated example, the opposite side 2288 is non-extendable, and the whole body 2120 is pushed towards the wall 192, although in other examples there may be one or more additional extendable bodies to work in cooperation with the ram 2282.

In the illustrated example, the wedge stabilization system 2280 includes projecting legs 2290 projecting away from the first track 2128 to hold the track 2128 away from the wall 192 when the ram 2282 is extended to push the body 2120 towards the wall. Each leg 2290 includes a foot 2292 to bear against the wall 192. Alternatively, the wedge stabilization system 2280 may otherwise wedge the carriage 2110 in position, such as by including a single leg opposite the ram, multiple rams, or the carriage body 2120 may be pushed into direct contact with the wall 192.

The wedge stabilization system 2280 is arranged to wedge the cutter carriage 2110 within the reactor vessel 190 with the cutter carriage 2110 touching an internal wall 192 of the reactor vessel 190 within a stabilization footprint 2200. The cutter carriage 2110 is operable to move the cutter 2100 within an operational plane 2148, and the stabilization footprint 2200 does not extend across the operational plane 2148.

As illustrated in FIGS. 29 and 30, the cutting device 2170 may be used for longitudinal cuts and/or angular cuts. In some examples, the cutting device 2170 can be used for longitudinal cuts and then used for angular cuts with no reconfiguration of the stabilization system required between longitudinal and angular cuts. The cutting device 2170 may be lifted out of the vessel 190 after making one of the angular or longitudinal cuts, suspended by the hoist system 2180 from a different point(s) on the device 2170, and then make the other of the angular or longitudinal cuts.

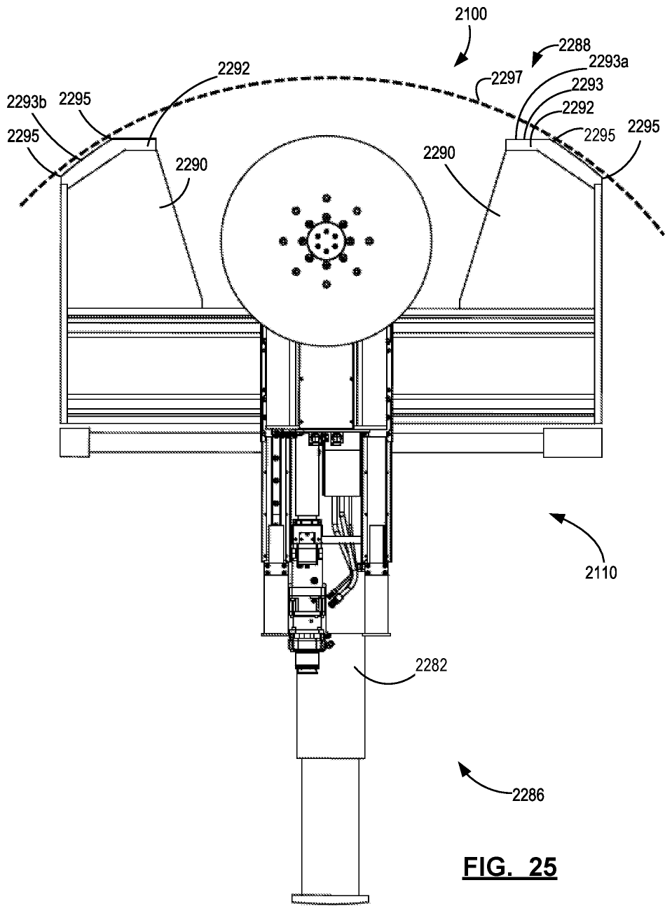

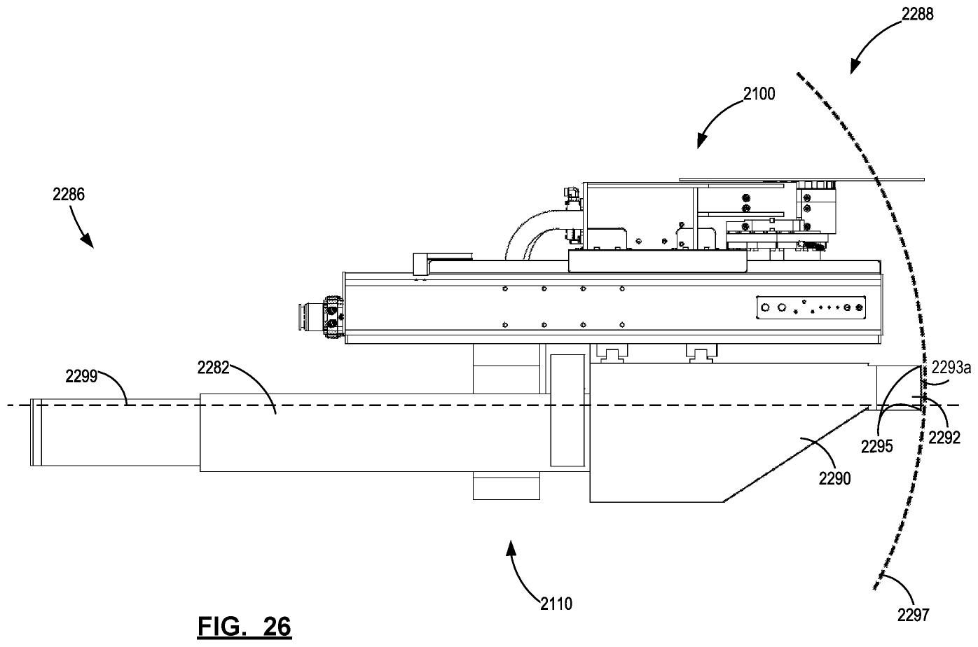

Referring to FIGS. 25 and 26, in the illustrated example the feet 2292 are shaped to together form a contact surface 2293 of the device 2170. The contact surface 2293 is shaped to stably contact the wall both when the reactor vessel cutting device 2170 is vertical and when the reactor vessel cutting device 2170 is horizontal, without reconfiguration between vertical and horizontal deployment.

The contact surface 2293 includes a first portion 2293a on a first foot and a second portion 2293b on a second foot. In each of the vertical and horizontal deployments, the contact surface 2293 includes a plurality of contact points at which the feet 2292 contact the wall. As illustrated in FIG. 25, in the horizontal configuration, the contact surface 2293 includes multiple points 2295 along the expected wall curvature 2297. As illustrated in FIG. 26, in the vertical configuration, the contact surface 2293 also includes multiple points 2295 (shown on the near foot 2292, and the same on the far foot not shown in FIG. 26) along the expected wall curvature 2297. The same contact surface 2293 used for the vertical deployment is used for the horizontal deployment without reconfiguration. The illustrated example includes generally planar surfaces forming the contact surface 2293 resulting in discrete contact points 2295 for a curved wall surface, however it will be understood that in other examples the contact surface 2293 may be curved with a curvature corresponding to the expected curvature of the vessel wall.

The contact points 2295 are also in a common plane 2295 along with a contact surface of the extendable system opposed to the contact surface 2293 (e.g., the ram 2282 in the illustrated example). The forces are all in the plane of the ram, keeping the moments as small as possible.

Referring now to FIG. 31, illustrated is a method 3000. The method 3000 includes, at step 3010, making a set of longitudinal cuts in an annular wall of the reactor vessel. For example, the cuts may be used with a cutting device such as cutting device 170. The annular wall may extend between a first end and a second end of the reactor vessel, such as annular wall 192. Each longitudinal cut of the set of longitudinal cuts is made extending parallel to a longitudinal axis of the annular wall, the set of longitudinal cuts spaced about the longitudinal axis and each extending along a common portion of the longitudinal axis. In other words, the cuts are angularly aligned with one another such that a plane perpendicular to the longitudinal axis extends through each of the longitudinal cuts.

At step 3012, the method 3000 includes fastening adjacent edges of the annular wall together across longitudinal cuts. Fastening the adjacent edges together may form adjacent portions into an annular ring of adjacent wall portions and fasteners used to hold adjacent edges together. For example, fastening the adjacent edges together may include installing a clamp (e.g., a hydraulic clamp) in each longitudinal cut to hold together adjacent edges of the annular wall. including angular segments of the annular wall held together by the clamps.

At step 3014, the method 3000 includes making an angular cut that intersects each of the longitudinal cuts. In some examples, the first end of the reactor vessel is an open end, and each longitudinal cut extends from the open end, and the angular cut frees an annular ring from a remainder of the annular wall, the annular ring including angular segments (e.g., segments 194) of the annular wall held together by the fasteners (e.g., fasteners 254, such as hydraulic clamps). Optionally, the angular cut is a series of angular cuts joining together to free the ring. Optionally, as the ring is cut free, the ring is propped up by wedges in the angular ring to keep the ring from twisting, or, additionally or alternatively, the fasteners (e.g., clamps) may extend past the angular cut to hold the ring in position above the remainder of the vessel (see, e.g., FIG. 21).

In some examples, the method 300 includes, at step 3016, removing the fasteners (e.g., fasteners 254, such as clamps) from the longitudinal cuts to separate the angular segments (e.g., segments 194).

In some examples, the method 3000 includes using a Minimum Quantity Lubrication (MQL) technique while making the set of longitudinal cuts and/or the annular cut. The MQL technique uses a spray of small droplets of a non-water-soluble lubricating fluid in a compressed air jet. The lubricating fluid is sprayed directly into the cutting zone. MQL may provide efficient lubrication and improved cutting performance without using huge flow of fluids. However, MQL may result in vision impairment due to, e.g., a fog developing as the lubricating fluid evaporates.

In some examples, the method 3000 includes circulating a fluid over a cutting area while making the set of longitudinal cuts and/or the annular cut. Circulating the fluid includes using a pump in the second end of the reactor vessel to feed fluid from the second end to the cutting area. When fluid is fed to the cutting area, excess fluid runs down back to the second end of the reactor vessel (e.g., second end 204 of vessel 190) where the pump is able to pick it up and recirculate once more. The fluid used in a circulating fluid system may be a water soluble fluid (including water itself). Circulating fluid may be done instead of, in addition to, or sequentially with MQL techniques. Circulating fluid may result in less vision impairment than using MQL techniques, but may be difficult at various stages of a cutting operation, such as when the cutting is occurring near the second end (e.g., near second end 204 of the vessel 190).

As discussed above, longitudinal cuts and angular cuts may be made by the same cutting device (e.g., device 2170) and/or made with similar devices differing only in the configuration of the stabilizing system. For example, the longitudinal cuts may be made by a first cutting device (e.g., cutting device 170) and the angular cuts may be made by a second cutting device (e.g., cutting device 1170) and/or the first cutting device in a second configuration (e.g., cutting device 170 with the magnets reconfigured to match the configuration of cutting device 1170). The device used to make the longitudinal cuts may differ from the device used to make the annular cuts only by the configuration of the stabilization system. In other words, the carriage body (e.g., carriage body 120) of the device used to make the longitudinal cuts may be the same as the carriage body (e.g., carriage body 1120) of the device used to make the annular cuts.

The present invention has been described here by way of example only. Various modification and variations may be made to these exemplary embodiments without departing from the scope of the invention, which is limited only by the appended claims.

1. A reactor vessel cutting device, comprising:
a. a hoist system;
b. a cutter; and
c. a cutter carriage secured to the hoist system to be suspended by the hoist system, and
d. wherein the cutter is secured to a carriage body of the cutter carriage to be carried by the carriage body,
e. wherein the cutter carriage includes a magnetic stabilization system secured to the carriage body and operable to hold the cutter carriage to a vessel wall of the reactor vessel, and
f. wherein the cutter carriage is operable to move the cutter relative to the vessel wall while the cutter carriage is held against the vessel wall by the magnetic stabilization system.

2. The device of claim 1, wherein the cutter carriage is operable to apply the cutter to the vessel wall in a mechanical cutting operation while the cutter carriage is held against the vessel wall by the magnetic stabilization system.

3. The device of claim 1, wherein the hoist system includes a support base and a retractable suspension line to which the cutter carriage is secured.

4. The device of claim 1, wherein the hoist system is configured to bear the weight of the cutter carriage and the cutter.

5. The device of claim 1, wherein the hoist system includes a chain fall hoist, and the cutter carriage is secured to a chain of the chain fall hoist.

6. The device of claim 5, wherein the hoist system includes two chains in parallel, and the cutter carriage is secured to each of the two chains.

7. The device of claim 1, wherein the magnetic stabilization system includes a plurality of magnets spaced apart from one another and arranged to each touch the vessel wall such that the cutter carriage is held against the vessel wall at multiple points.

8. The device of claim 7, wherein the multiple points are within a stabilization footprint on the vessel wall, and the cutter carriage is operable to move the cutter within an operational plane, and the stabilization footprint does not extend across the operational plane.

9. The device of claim 1, wherein the magnetic stabilization system includes electromagnets.

10. The device of claim 1, wherein the magnetic stabilization system includes an outside face to be directed towards the vessel wall, and a gripper insert is set in the outside face, the gripper insert including an abrasive surface.

11. The device of claim 10, wherein the gripper insert is a carbide gripper.

12. The device of claim 10, wherein the outside face is a surface of a magnet.

13. The device of claim 1, wherein the cutter carriage incudes a first body with a first track and a second body with a second track, the second body secured to the first body to move along the first track, and the cutter secured to the second body to move along the second track.

14. The device of claim 13, wherein the first track and the second track are linear tracks and extend perpendicular to one another.

15. The device of claim 1, wherein the cutter includes a circular saw blade.

16. A reactor vessel cutting device, comprising:
a. a hoist system;
b. a cutter; and
c. a cutter carriage secured to the hoist system to be suspended by the hoist system, and
d. wherein the cutter is secured to a carriage body of the cutter carriage to be carried by the carriage body,
e. wherein the cutter carriage includes a wedge stabilization system secured to the carriage body and operable to hold the cutter carriage against a vessel wall of the reactor vessel by wedging the cutter carriage within the reactor vessel, and
f. wherein the cutter carriage is operable to move the cutter relative to the vessel wall when the cutter carriage is held against the vessel wall.

17. The device of claim 16, wherein the cutter carriage is operable to apply the cutter to the vessel wall in a mechanical cutting operation while the cutter carriage is held against the vessel wall by the wedge stabilization system.

18. The device of claim 16, wherein the hoist system includes a support base and a retractable suspension line to which the cutter carriage is secured.

19. The device of claim 16, wherein the hoist system is configured to bear the weight of the cutter carriage and the cutter.

20. The device of claim 16, wherein the hoist system includes a chain fall hoist, and the cutter carriage is secured to a chain of the chain fall hoist.

21. The device of claim 20, Wherein the hoist system includes two chains in parallel, and the cutter carriage is secured to each of the two chains.

22. The device of claim 16, wherein the wedge stabilization system includes an extendable ram secured to the carriage body and including a foot for bearing against an internal wall of the reactor vessel.

23. The device of claim 22, wherein the cutter carriage includes only one extendible ram, the extendible ram secured to the carriage body and arranged to extend the foot on a first side of the cutter carriage to bear against the internal wall of the reactor vessel and force an opposite side of the cutter carriage towards an opposite surface of the internal wall of the reactor vessel.

24. The device of claim 16, wherein the wedge stabilization system is arranged to wedge the cutter carriage within the reactor vessel with the cutter carriage touching an internal wall of the reactor vessel within a stabilization footprint, and the cutter carriage is operable to move the cutter within an operational plane, and the stabilization footprint does not extend across the operational plane.

25. The device of claim 16, wherein the cutter carriage incudes a first body with a first track and a second body with a second track, the second body secured to the first body to move along the first track, and the cutter secured to the second body to move along the second track.

26. The device of claim 25, wherein the first track and the second track are linear tracks and extend perpendicular to one another.

27. The device of claim 16, wherein the cutter includes a circular saw blade.

28. A method of cutting a reactor vessel, comprising:
a. making a set of longitudinal cuts in an annular wall of the reactor vessel, the annular wall extending between a first end and a second end of the reactor vessel, each longitudinal cut of the set of longitudinal cuts extending parallel to a longitudinal axis of the annular wall, the set of longitudinal cuts spaced about the longitudinal axis and each extending along a common portion of the longitudinal axis;
b. fastening adjacent edges of the annular wall together across longitudinal cuts; and
c. making an angular cut that intersects each of the longitudinal cuts.

29. The method of claim 28, wherein fastening the adjacent edges together includes installing a clamp in each longitudinal cut to hold together adjacent edges of the annular wall.

30. The method of claim 29, wherein the first end of the reactor vessel is an open end, and each longitudinal cut extends from the open end, and the angular cut frees an annular ring from a remainder of the annular wall, the annular ring including angular segments of the annular wall held together by the clamps.

31. The method of claim 29, further comprising removing the clamps from the longitudinal cuts to separate the angular segments.

32. The method of claim 29, wherein each clamp is a hydraulic clamp.

33. The method of claim 28, further comprising using Minimum Quantity Lubrication (MQL) while making the set of longitudinal cuts and/or the annular cut.

34. The method of claim 28, further comprising circulating a fluid over a cutting area while making the set of longitudinal cuts and/or the annular cut, circulating the fluid using a pump in the second end of the reactor vessel to feed fluid from the second end to the cutting area.

35. The method of claim 28, wherein the longitudinal cuts are made with a reactor vessel cutting device in a first configuration and the angular cut is made with:
a. the reactor vessel cutting device in a second configuration in which a saw carriage of the reactor vessel cutting device is rotated 90 degrees relative to the first configuration, or
b. a second of the reactor vessel cutting device, a saw carriage of the second of the reactor vessel cutting device being rotated when the angular cut is made by 90 degrees relative to the saw carriage of the reactor vessel cutting device when the longitudinal cuts are made.

36. The method of claim 35, wherein the reactor vessel cutting device is the reactor vessel cutting device of claim 16.

37. A reactor vessel cutting device, comprising:
a. a hoist system;
b. a mechanical cutter; and
c. a cutter carriage secured to the hoist system to be suspended by the hoist system, and
d. wherein the cutter is secured to a carriage body of the cutter carriage to be carried by the carriage body,
e. wherein the cutter carriage includes a stabilization system secured to the carriage body and operable to hold the cutter carriage against a vessel wall of the reactor vessel,
f. wherein the cutter carriage is operable to apply the cutter to the vessel wall in a mechanical cutting operation when the cutter carriage is held against the vessel wall by the stabilization system, and
g. wherein the hoist system is configured to bear the weight of the cutter and the cutter carriage during the mechanical cutting operation and the stabilization system is configured to carry cutting forces generated during the mechanical cutting operation.

38. The device of claim 37, wherein the hoist system includes a support base and a retractable suspension line to which the cutter carriage is secured.

39. The device of claim 37, wherein the hoist system is configured to bear the weight of the cutter carriage and the cutter.

40. The device of claim 37, wherein the hoist system includes a chain fall hoist, and the cutter carriage is secured to a chain of the chain fall hoist.

41. The device of claim 40, Wherein the hoist system includes two chains in parallel, and the cutter carriage is secured to each of the two chains.

42. The device of claim 37, wherein the cutter carriage incudes a first body with a first track and a second body with a second track, the second body secured to the first body to move along the first track, and the cutter secured to the second body to move along the second track.

43. The device of claim 42, wherein the first track and the second track are linear tracks and extend perpendicular to one another.

44. The device of claim 37, wherein the cutter includes a circular saw blade.
